(19) United States
(12) Patent Application Publication
(10) Pub. No.: US 2012/0143655 A1
(43) Pub. Date: Jun. 7, 2012

(54) CHECKOUT APPARATUS AND WORKING STATE MEASUREMENT APPARATUS

(75) Inventors: Takamitsu Sunaoshi, Yokohama-shi (JP); Kiminori Toya, Kawasaki-shi (JP); Hideki Nukada, Yokohama-shi (JP); Hideichi Nakamoto, Tokyo (JP)

(73) Assignee: KABUSHIKI KAISHA TOSHIBA

(21) Appl. No.: 13/340,825

(22) Filed: Dec. 30, 2011

Related U.S. Application Data
(63) Continuation of application No. PCT/JP2009/061997, filed on Jun. 30, 2009.

(51) Int. Cl. G06Q 10/06

(52) U.S. Cl. 705/7.41

(57) ABSTRACT

According to one embodiment, a checkout apparatus includes a counter, a scanner, a register terminal, and a recognition unit. The counter is embedded at least one weight meter and to be put at least one of target objects. The scanner reads codes attached to the target objects. The register terminal settles payment for the target objects. The recognition unit identifies the target objects by referring to working property category information pieces indicating a category in scan work for the target objects, based on the codes read by the scanner, and obtains signals that represent states each including one of steady work and unsteady work for an operator, based on a time history of a weight of the target objects.

### CROSS REFERENCE TO RELATED APPLICATIONS

This application is a Continuation Application of PCT Application No. PCT/JP2009/061997, filed Jun. 30, 2009, the entire contents of which are incorporated herein by reference.

### FIELD

Embodiments described herein relate generally to a checkout apparatus and a working state measurement apparatus.

### BACKGROUND

Common among stores such as supermarkets are checkout apparatuses in each of which a counter as a rectangular table is set in parallel with a moving direction of shoppers in order to efficiently proceed with sales tasks. A basket which each shopper carries with purchased items in are put on the counter, and an operator transports the items one after another while simultaneously carrying out sales register work. In this case, a checkout scanner as a scan unit including a barcode scanner to achieve the sales register work such as reading of barcode information, and a register terminal as a casher unit to carry out settling work for paying and receiving money are provided as respectively separate devices on the counter. The operator picks up one after another of items from the basket, and scans barcodes attached to the items with the barcode scanner. The operator then puts and arranges the items into another basket for receiving, which is put also on the counter on a downstream side along the moving direction of shoppers. This scan work occupies a very high time percentage of the whole register work, requires speediness, accuracy, and good care, and therefore easily burdens the operator. If fatigue or a feeling of fatigue accumulates due to such various burdens, work efficiency deteriorates and may influence quality of services for shoppers.

Recently, approaches are made to reduce fatigue of operators or a feeling of fatigue by understanding working states of the operators and by providing adequate solutions based on results understood. Fatigue or a feeling of fatigue differs among individual persons, and changes depending on daily conditions of each person. Therefore, measurement needs to be performed arbitrarily. Further, measurement results need to be reported in real time in order to provide a timely solution.

As a technique for measuring a working state of an operator, there is a technique for analyzing a biological signal of the operator. A method for determining a load state of a driver of a car, as an operator, from a heart beat and a breath signal of the operator has been disclosed (See e.g., JP-A. No. 2002-10995(KOKAI)). Further, a technique for evaluating properties of drive work by measuring a myogenic potential has been disclosed (See e.g., JP-A. No. 2006-271648(KOKAI)). Still further, a technique for measuring operation from a signal from an acceleration sensor attached to an operator has also been disclosed (See e.g., JP-A. No. 1997-117440(KOKAI)). Still further, a technique for analyzing work operation by imaging a working state of an operator with use of a camera and by analyzing an image thereof has been disclosed (See e.g., JP-A. No. 2006-209468(KOKAI)).

### BRIEF DESCRIPTION OF THE DRAWINGS

FIG. 1 is a view illustrating a checkout apparatus according to the present embodiment;

FIG. 2 is a view illustrating a checkout scanner part including a cross-sectional view of a periphery of a sensor table provided on a counter of the checkout apparatus;

FIG. 3 is a block diagram illustrating the checkout apparatus;

FIG. 4 is a block diagram focused on data of the checkout apparatus;

FIG. 5 is a block diagram illustrating a working state recognition unit;

FIG. 6 illustrates an example of data obtained by a weight meter;

FIG. 7 is a graph explaining time points and time periods extracted by a work time extraction unit;

FIG. 8 is a flowchart indicating an operation in the working state recognition unit;

FIG. 9 is a flowchart indicating a processing method for weight data;

FIG. 10 is a block diagram explaining operation of the work content analyzing unit;

FIG. 11A is a graph illustrating an example of signals obtained by scan work of an operator A;

FIG. 11B is a graph illustrating an example of signals obtained by scan work of an operator B;

FIG. 12A is a graph illustrating a relationship between a work state signal and subjective points for the operator A;

FIG. 12B is a graph illustrating a relationship between a work state signal and subjective points for the operator B; and

FIG. 13 illustrates another example of the work rhythm signal when weight coefficients are changed.

### DETAILED DESCRIPTION

However, in these methods of measuring a biological signal or an operation signal, there is a need of attaching various sensors to an operator, which may stress the operator and may hinder operationality. To obtain an accurate biological signal, the operator needs to be quiet, i.e., work is temporarily suspended. Analysis on a camera image results in a low sampling rate, and causes difficulties in obtaining a sufficient sampling rate to analyze a working state in detail. There further is a problem that sequential data cannot be obtained when a part being monitored is hidden during work. Still further, an analysis result is hard to obtain instantaneously when a separate device is used to associate content of work with obtained data or when a particular motion is to be extracted and analyzed afterward.

In general, according to one embodiment, a checkout apparatus includes a counter, a scanner, a register terminal, and a recognition unit. The counter is configured to be embedded at least one weight meter and to be put at least one of target objects. The scanner is configured to read codes attached to the target objects. The register terminal is configured to settle payment for the target objects. The recognition unit is configured to identify the target objects by referring to working property category information pieces indicating a category in scan work for the target objects, based on the codes read by the scanner, and to obtain signals that represent states each including one of steady work and unsteady work for an operator, based on a time history of a weight of the target objects measured by the weight meter.

The checkout apparatus and a working state measurement apparatus according to the embodiment will be explained with reference to the drawings. In the embodiment below, like reference numbers denote like elements, and no duplicate descriptions will be given.

A configuration of the checkout apparatus according to the embodiment will be described with reference to FIG. 1.

A checkout apparatus 1 according to the embodiment includes, when roughly divided, a register terminal 101, a checkout scanner 108, a register table 107, a sensor table 113a, a sensor table 113b, a guard 114, and a counter 115. Further, the register terminal 101 includes a shopper display 102, a touch panel 103, a keyboard 104, a receipt printer 105, and a drawer 106. The checkout scanner 108 includes a shopper display 109, a touch panel 110, a keyboard 111, and a code scanner 112.

FIG. 1 shows a state of the checkout apparatus 100 viewed from an operator's side. The term “operator” is a generic name representing a worker, a cashier, checker, and a register operator. The term “operator's side” means a position where the operator can input data, facing the register terminal 101 and the checkout scanner 108, e.g., a near side relative to the checkout scanner 108 and counter 115 in the example of FIG. 1.

In the checkout apparatus 100, the checkout scanner 108 as a vertical type scanner is provided to stand at a peripheral part in a shopper's side opposite to the operator's side in the substantial center of an I-shaped (rectangular) counter 115. Further, at a position on a downstream side of the checkout scanner 108 along a flow of item sales work, the register terminal 101 as a payment settlement unit is configured to be set adjacent to the counter 115 on the register table 107. That is, in the example of FIG. 1, when the operator stands at the operator's side and faces the checkout scanner 108, a side where the register terminal 101 in the leftward side is placed is the downstream side where payment is settled during the item sales work. In other words, a place where items are put before items are read in item reading work (hereinafter also referred to as scan work) is called an upstream side, and a place where the items are put after reading is called a downstream side. Although the register table 107 has a different case shape from that of the counter 115, the register table 107 is not limited to this shape and can have any shape which allows the register terminal 101 to be mounted on. An L-shape or a C-shape which integrates the register table 107 and the counter 115 is also possible.

Further, a sensor table 113a and a sensor table 113b are provided on a flat surface of the counter 115 respectively in both of the left and right sides of the operator who faces the checkout scanner 108. In the example of FIG. 1, the sensor table 113a is a place where a shopper puts a basket with unpaid items in, e.g., on the upstream side. The sensor table 113b is a place where the operator puts another basket into which the operator puts items read with the code scanner 112, e.g., on the downstream side.

The guard 114 is a guard fence which prevents a basket from colliding into the checkout scanner 108 when the operator or shopper moves the basket over the flat surface of the counter 115.

Next, the register terminal 101 will be described in detail.

The shopper display 102 displays information input by the touch panel 103 and keyboard 104 by the operator in a manner that shoppers can recognize the information. The touch panel 103 and keyboard 104 are used to allow the user to carry out a processing operation for inputting types of items or prices. The receipt printer 105 is used to print receipts. The drawer 106 is used to allow the operator to put in and take out money.

Next, the checkout scanner 108 according to the embodiment will be described in detail.

The shopper display 109 is used to display information such as types of items and prices and to allow a shopper to recognize the information. The touch panel 110 and keyboard 111 are used mainly to carry out register work for items attached with no barcode. The shopper display 109 described above, touch panel 110, and keyboard 111 operate in the same manner as the shopper display 102, touch panel 103, and keyboard 104.

The code scanner 112 carries out a reading processing of reading barcode information attached to each item through a read window which has a flat box-like shape and is provided in a standing surface facing the operator's side. The reading processing is performed by reflecting a laser beam or the like which is emitted through the read window on a barcode, by making reflection light thereof enter again through the read window, and by receiving reflection light by the light receiver.

The checkout scanner 108 and register terminal 101 can electrically transmit/receive signals through cables or wirelessly. Information input to the checkout scanner 108 is sent to the register terminal 101.

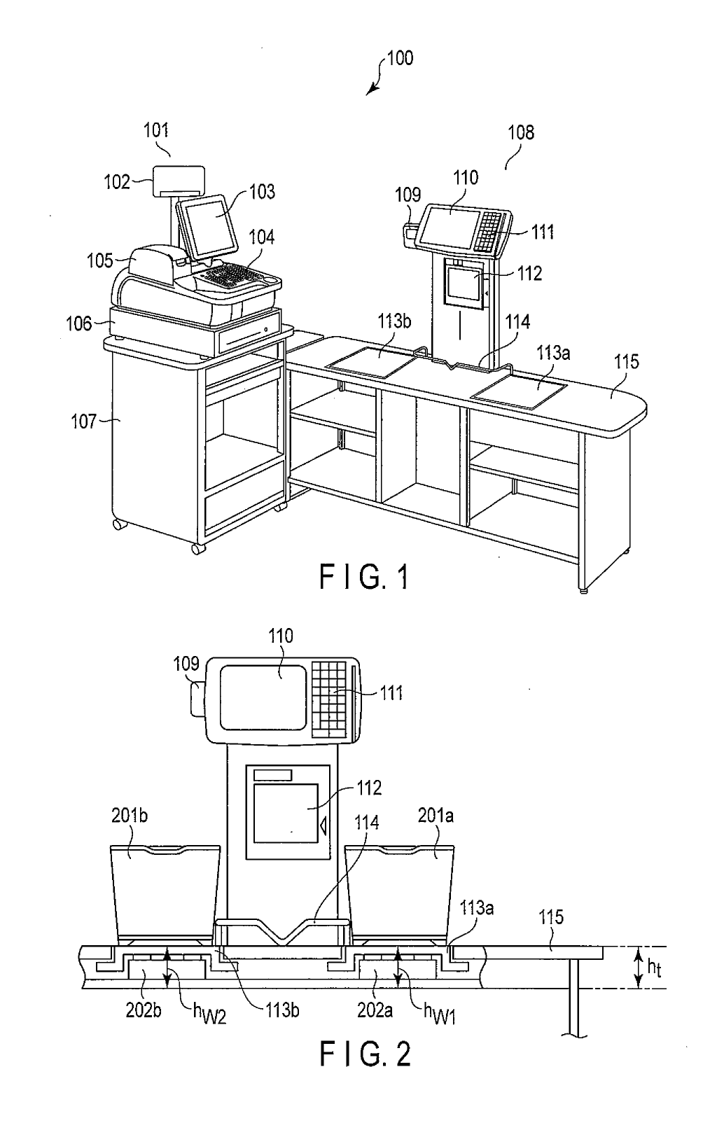

Next, a cross-section of the periphery of the sensor tables which are provided on the counter 115 of the checkout apparatus 100 will be described in detail with reference to FIG. 2. As shown in FIG. 2, weight meters 202a and 202b are provided to be embedded in the counter 115. The sensor tables are fixed to an upper part of the weight meters. On the sensor table 113a on the upstream side where the basket 101a containing unpaid items is, a height hw1 from a reference level of a bottom surface which supports the weight meter 202a to an upper surface of the sensor table 113a is set to be not greater than a height ht from the same reference level of the bottom surface as described to an upper surface of the counter 115. This is because, when an operator or a shopper slides a heavy basket including items over the counter to above the sensor table 113a, the operator or shopper can then smoothly move the basket without lifting the basket. On the sensor table 113b on the downstream side where a basket 201b to contain scanned (read) items is placed, a height hw2 from a reference level of a bottom surface which supports the weight meters 202b to an upper surface of the sensor table 113b is set to be greater than the height ht from the same reference level of the bottom surface to the upper surface of the counter 115 when a total weight of the basket and items are not greater than a set weight (for example, 10 kgf). This is because burdens on the operator or shopper can be reduced by making the basket containing the items easily movable from the sensor table 113b to above the counter 115.

Each of the weight meters 202a and 202b includes a strain gauge whose output is dependent on a sensor table and a weight applied to the sensor table, and a circuit which obtains an analogue output signal from the output of the gauge through a bridge circuit and an amplifier. The checkout scanner 108 includes a converter which converts the analogue signals output from the weight meters 202a and 202b into a serial signal compatible with USB communication. Further, when a basket is positioned in contact with the guard 114 provided that the basket is drawn to the checkout scanner 108, the sensor table 113a is sufficiently wide at the position where the basket does not project over the sensor table 113a.

Between each of the sensor tables 113a and 113b and the counter 115, only a slight gap of several millimeters exists. Even when a coin, a card, or a thin item drops into the gap, a receiving part is provided in the sensor tables so that the falling object may not fall down on parts of the weight meters. By coloring the sensor tables 113a and 113b in a different color from the counter 115 or by drawing colored lines surrounding the sensor tables 113a and 113b along edges of the tables, baskets can be steadily put on the sensor tables 113, and changes in weight can be captured by the weight meters 202. Further, the counter 115 may be divided into halves, and a whole upper surface of a half of the counter 115 may be used as a sensor table 113a or 113b.

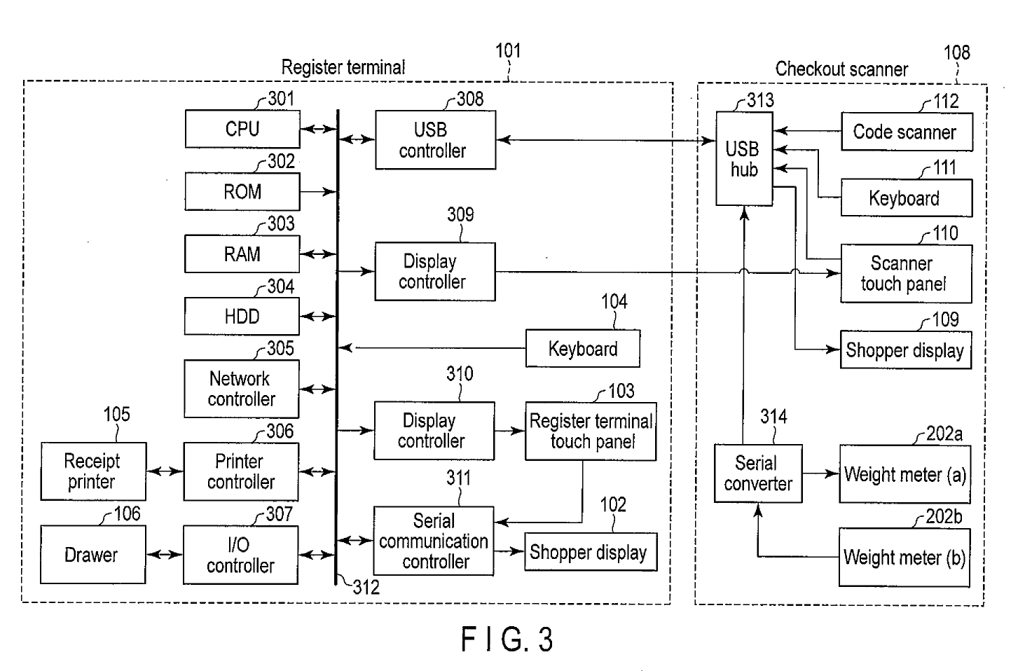

Next, a block diagram illustrating the checkout apparatus 100 according to the embodiment will be described in detail with reference FIG. 3. The register terminal 101 includes a CPU 301 as a control means, and connects, through a bus line 312, the ROM 302 as a storing medium which prestores fixed data such as an operating system and an account processing program, and the RAM 303 which stores variable data to be freely rewritable. A HDD 304 is connected through the bus line 312, and the HDD 304 stores an item master file, a sales file which stores/maintains sales information according to account registration, and a customer file.

The CPU 301 downloads an item master file from a shop server through a network by controlling a network controller 305 and stores the file into the HDD 304 when starting up the account processing program. A display controller 310 generates an operation screen on the touch panel 103 of the register terminal 101, and reads information input from the touch panel 103 through a serial communication controller 311. The serial communication controller 311 transmits item names and price information to the shopper display 102. Receipts are printed by a receipt printer 105 through a printer controller 306 by operating the keyboard 104 of the register terminal 101. The drawer 106 is controlled to open/close by an I/O controller 307.

Further, a screen of the touch panel 110 of the checkout scanner 108 is generated by low voltage differential signaling (LVDS). Operation information of the touch panel 110 included in the checkout scanner 108, operation information of the keyboard 111, information read by the code scanner 112, and serial data obtained by serially converting data of the weight meters 202a and 202b by the serial converter 314 are transmitted to a USB controller 308 of the register terminal 101 through the USB hub 313 equipped in the checkout scanner 108. Item names and price information are transmitted from the register terminal 101 to the shopper display 109 of the checkout scanner 108 through the USB controller 308.

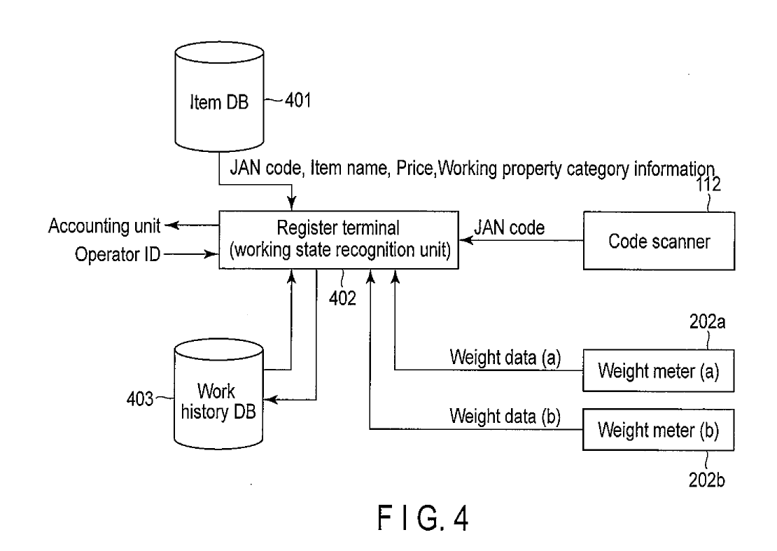

Next, data flow in the checkout apparatus 100 will be described in detail with reference FIG. 4. When an operator starts up the checkout scanner 108, a working state recognition unit 402 batch-downloads data in an item DB (database) 401 stored in the shop server through a network. Hereinafter, data processing is performed by the working state recognition unit 402. The item DB 401 registers Japan Article Number (JAN) codes (barcodes) of items handled in the shop, item names, prices, and item categories. The item categories categorize types divided into foods, commodities, cultural items, and subcategorized types thereof. As the operator makes the scanner 112 to read a JAN code adhered to an item, the JAN code is transmitted to the working state recognition unit 402. The working state recognition unit 402 checks the JAN code registered in the item DB 401 with the read JAN code, and settles an account by referring to an item name, price, and an item category of the read item. The embodiment is not limited to the JAN codes but may employ various codes such as QR codes and GS1 data bars.

In addition, the two weight meters 202a and 202b successively transmit, to the working state recognition unit 402, weight data (a) and weight data (b) which are measured by the respective weight meters. When an operator starts register work, the operator firstly inputs an operator ID to the working state recognition unit 402, and checks the input operator ID with operator IDs stored in an operator DB (not shown) stored in an external shop server provided, and registers operator information of the checkout apparatus 100 into the working state recognition unit 402. Further, a work history DB 403 sends, to the working state recognition unit 402, a working state of work that an operator corresponding to the operator ID registered carries out in the past, in accordance with a request from the working state recognition unit 402. The work history DB 403 receives and stores a working state of the operator from the working state recognition unit 402. In the present embodiment, the working state recognition unit 402 is included in the register terminal 101. However, the working state recognition unit 402 is not limited to this embodiment and may alternatively be included in the counter 115 or checkout scanner 108 or may be provided at any place where data communication is possible.

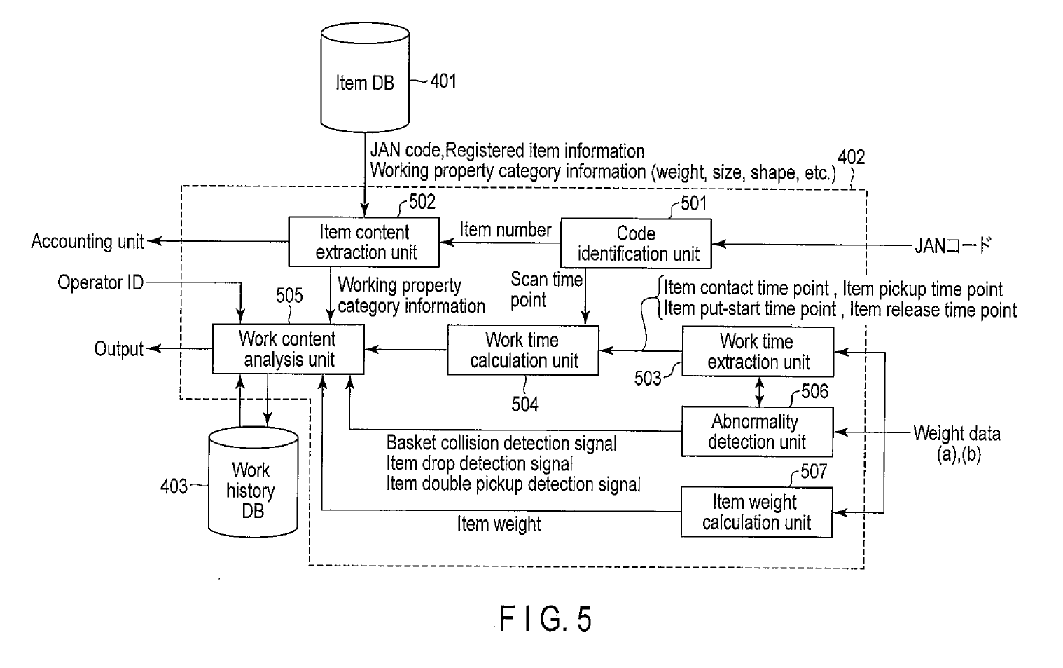

Next, data processing in the working state recognition unit 402 will be described in more detail with reference to FIG. 5.

The working state recognition unit 402 includes a code identification unit 501, an item content extraction unit 502, a work time extraction unit 503, a work time calculation unit 504, a work content analysis unit 505, an abnormality detection unit 506, and an item weight calculation unit 507.

The code identification unit 501 performs code-identification of identifying a JAN code of an item as a digit sequence with use of the code scanner 112, and sends an item number as an identified digit sequence, to the item content extraction unit 502. Also, the code identification unit 501 extracts a time point when the code scanner 112 reads the JAN code, and sends the time point to the work time calculation unit 504.

The item content extraction unit 502 transmits an item name, a price, and an item category which correspond to the checked item number, to an external accounting unit, and also sends working property category information pieces to the work content analysis unit 505. The working property category information pieces gather item parameters which influence scan work for items, and is a set of data which symbolically categorizes or numerically expresses item shapes (degree of easiness to handle and degree of easiness to deform, etc.), item sizes (whether two hands are required to grab or not), item weights, conditions of code adhesion surfaces (degree of easiness of scanning codes depending on a flat or rough surface), and conditions of item content (inclinable or not or easy to change or not).

The working property category information pieces may be changed in accordance with work results of operators at an arbitrary time. For example, working property category information pieces are expressed as a numerical value which indicates that scan work is easier for an operator as the numerical value increases. In this case, when a shape of an item is changed by renewal or when a plurality of identical items are sold together as a set, easiness of handling and a wrapping condition are considered to change. At this time, when an operator finds a difficulty in proceeding with scan work, a working state which the operator feels can be reflected by decreasing the numerical value of the working property category information.

The work time extraction unit 503 extracts an item contact time point, an item get time point, an item put-start time point and an item release time point, as time information pieces, from the weight data (a) and weight data (b), and sends the time information pieces to the work time calculation unit 504.

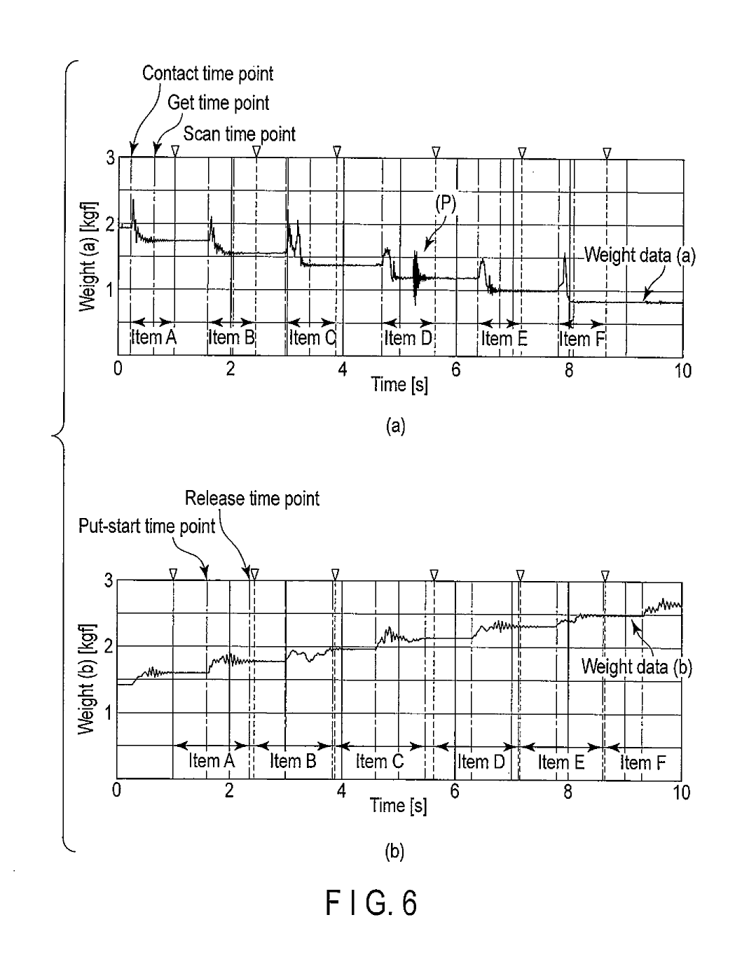

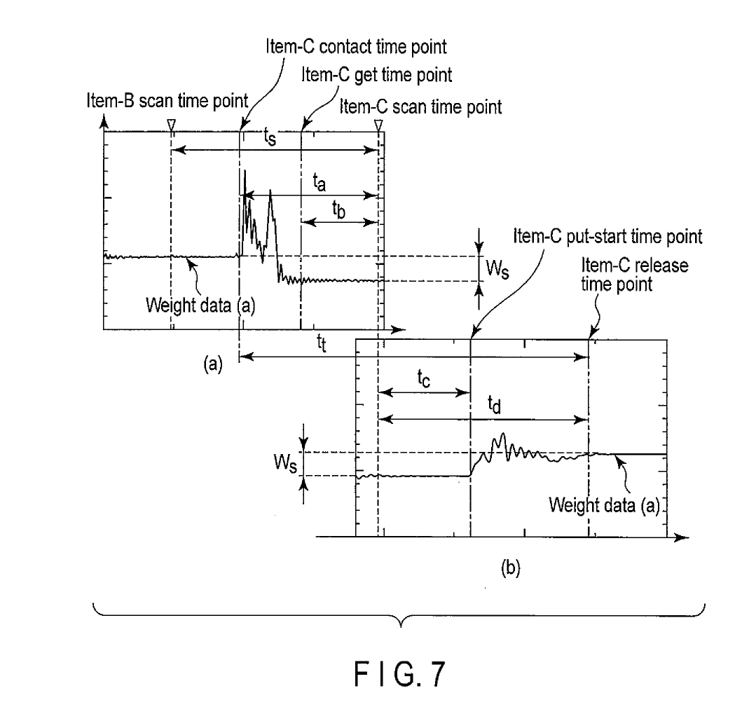

Now, a processing method of the weight data (a) and weight data (b) which are used by the abnormality detection unit 506, item weight calculation unit 507, and work time extraction unit 503 will be described in detail with reference to FIGS. 6 and 7, as examples of data acquired.

In FIGS. 6 and 7, the horizontal axes represent an elapsed time from a reference, and the vertical axes respectively represent weights obtained by the weight meters 202. The weight data (a) indicated by a graph in FIG. 6(a) expresses changes of the weight measured by the weight meter 202a in the work of picking up and scanning one after another of items from a basket, where six items are picked up from the basket. Similarly, the weight data (b) shown in the graph of FIG. 6(b) expresses changes of the weight measured by the weight meter 202b in the work of putting one after another of the scanned items into a basket, where parts corresponding to the foregoing six items are shown. In these graphs, scan time points obtained by the code identification unit 501 are indicated by broken lines. In FIG. 6(a), contact time points for items are indicated by one-dot chain lines, and obtaining time points for items are indicated by two-dot chain lines. In FIG. 6(b), display start points for the items are one-dot chain lines, and release time points for the items are indicated by two-dot chain lines. FIG. 7 is a graph which extracts time periods before and after scan work performed for the item C.

When the operator touches an item by a hand to pick up the item from a basket, a force is just applied to the item, and the weight data (a) measured by the weight meter 202a increases once. Subsequently, as the item is brought up, the weight data (a) gradually decreases. When the item perfectly leaves the basket or another item, the weight data (a) then indicates a constant value which is smaller than a value which had been indicated before the item was picked up. A difference Ws between the constant value of the weight data (a) before the item was picked up and the constant value of the weight data (a) after the item was picked up is an item weight. A time point when the weight data (a) turned to start increasing is defined as an item contact time point, and a time point when the weight data (a) became again a constant value is defined as an item get time point.

When a scanned item is put into a basket as a receiver, the operator brings the item into contact with the basket or any other item which has already been put in. Then, the weight data (b) measured by the weight meter 202b increases. Subsequently, the weight data (b) decreases slightly until the operator moves the hand off of the item. The weight data (b) then indicates a constant value when the item increases to be greater than a value which had been indicated before the item was put in. A difference between the value of the weight data (b) before the item was put in and the constant value after the item was put in is equal to the aforementioned item weight Ws.

A time point when the weight data (b) turned to start increasing is defined as an item put-start time point, and a time point when the weight data (b) became again a constant value is defined as an item release time point.

The abnormality detection unit 506 receives each of the weight data and detects an unsteady state different from a steady state of scan work, from conditions of waveforms of each of the weight data, and sends an abnormality recognition signal indicating work in the unsteady state, to the work content analysis unit 505. The unsteady state refers to, for example, a case that a change occurs in weight when an operator touches a basket or drops an item into a basket except for touch or getting of items by the operator during scan work in the steady state. Changes in weight except for work in the steady working state are defined as weight fluctuation signals.

An abnormality recognition signal processing will be described with reference to FIG. 6. The weight data at a part denoted at (P) in FIG. 6 is a change in weight other than touching or getting of items by the operator. Therefore, the weight data in this part is a weight fluctuation signal. For example, a signal waveform as denoted at (P) in FIG. 6 appears when an item is brought into contact with the edge of a basket before completely taking out the item after picking up the item from the basket. Further, though not shown, if a vibration waveform is observed after a temporary reduction from the constant value after getting the item in the weight data, this waveform indicates an operation that the operator returns an item after having got two items together. Further, if a vibration waveform is observed after the same level as a constant value before making contact with an item is obtained, this waveform indicates an operation that the operator dropped, into the basket, the item which the operator had caught. From these waveforms, these weight fluctuation signals are respectively defined as a basket collision detection signal, an item double pickup detection signal, and an item drop detection signal. These weight fluctuation signals are detected and defined as abnormality recognition signals.

The item weight calculation unit 507 calculates the aforementioned item weight Ws, and sends the weight to the work content analysis unit 505. If the working property category information pieces already include the item weight, the item weight Ws need not be calculated from the weight data (a) and weight data (b).

The work time calculation unit 504 receives an operator ID from the external operator DB, and receives a history concerning a past working state which the operator ID carried out from the work history DB 403. Further, the work time calculation unit 504 receives a scan time point from the code identification unit 501, and receives time information pieces from the work time extraction unit 503, including an item contact time point, an item get time point, an item put-start time point, and an item release time point. Based on the time information pieces, the work time calculation unit 504 calculates a contact scan time period ta, a get scan time period tb, a scan put-start time period tc, a scan release time period td, and a scan time interval ts, and sends these time points and interval, as read information pieces, to the work content analysis unit 505.

Here, an example of a method for calculating read information pieces in the work time calculation unit 504 will be described with reference to FIG. 7. The contact scan time period ta can be obtained from the weight data (a), and is a time difference between the scan time point and the item contact time point for the item C. The get scan time period tb can be also obtained form the weight data (a), is a time difference between the scan time point and the item get time point for the item C. Further, the scan put-start time period tc can be obtained from the weight data (b), and is a time difference between the scan time point and the item put time point for the item C. The scan release time period td can be obtained from the weight data (b), and is a time difference between the scan time point and the item release time point for the item C.

Further, the scan interval time is between the scan time point for the item C and the scan time point for the item B which was handled immediately before is calculated. A time period tt which is an addition of the contact scan time period ta and the scan release time period td is a total time period that the item C is handled. By obtaining a difference between an item release time point and an item contact time point for an item to be next dealt with, a degree of overlap in work of simultaneously putting an item A by the left hand and getting a next item by the right hand can be evaluated. For example, in the example of FIG. 6, substantially at the same time when an operator started putting the item A, the operator touched the item B before releasing the item A. It is hence found that the operator tried picking up the next item B while putting the item A by the left hand. Further, by calculating a difference between a scan time point and an item contact time point for an item to be handled next, whether the left or right hand grabs an item during scanning can be estimated. If the hand differs from an ordinarily used hand, an abnormality such as a mistake in scanning can be estimated to have occurred. Thus, by analyzing the weight data (a) and weight data (b) by the work content analysis unit 505, not only can the item weight be simply calculated but also the work content of the operator can be recognized. In addition, time points when scan work is started and finished for each item and a spent time period can be calculated. Still further, working states other than usual can be extracted.

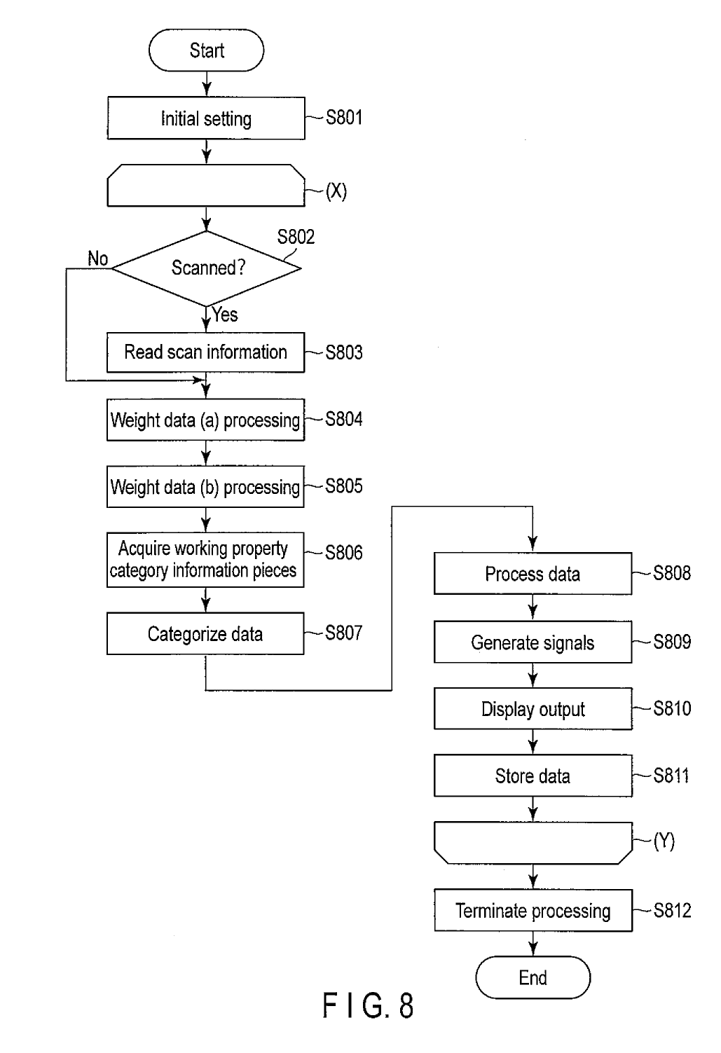

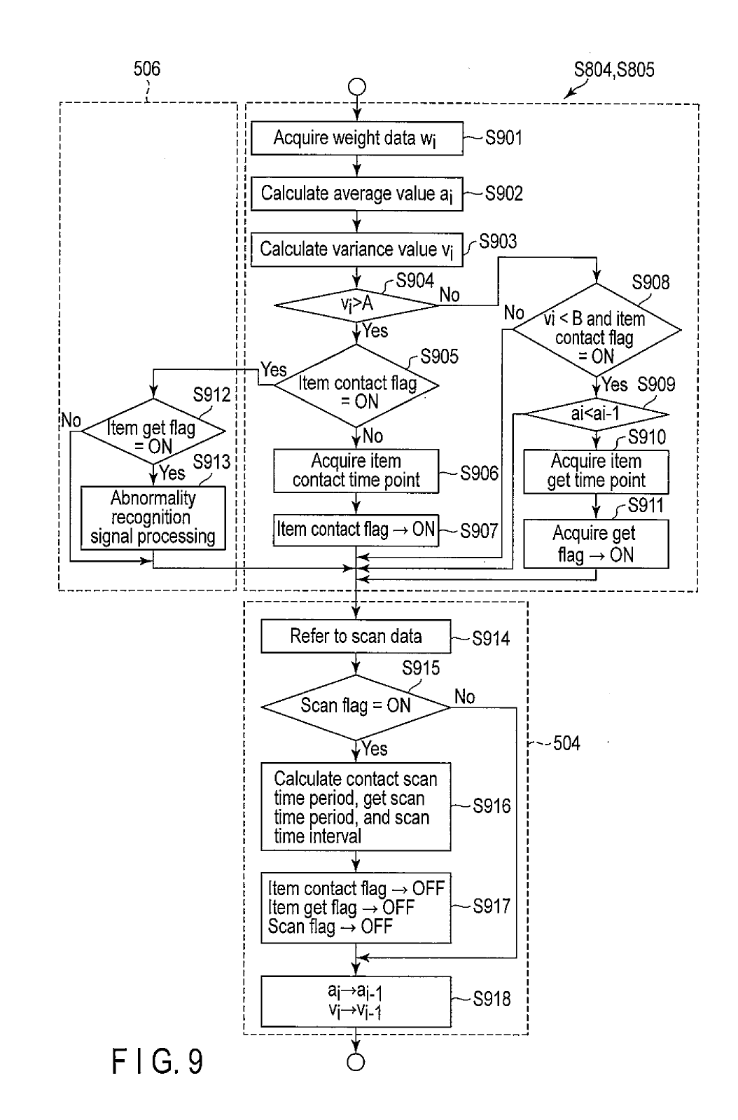

Next, processing for extracting the work time points of individual items and for calculating work time periods at the working state recognition unit 402 will be described in detail by using flowcharts shown in FIGS. 8 and 9.

FIG. 8 is a flowchart showing a flow of processing at the working state recognition unit 402 for extracting a working state to be practiced by the register terminal 101.

When the working state recognition unit 402 in the register terminal 101 starts up, initial setting is performed, for example, to read an operator ID, confirm access to the item DB 401, confirm access to the work history DB 403, and confirm connection to the code scanner 112 in the checkout scanner 108 and to the weight meters 202(a) and 202(b) (step S801). Subsequently, during scan work for items, processing from reading of various data to generation and storage of signals is repeatedly carried out. That is, in FIG. 8, the processing of steps from S802 to S811 between (X) and (Y) is repeated. This repetition is carried out in cycles of, for example, 1 millisecond.

At first, whether scan information indicating that scan work has been performed is input or not is confirmed in step S802. If the scan information is input, the code identification unit 501 obtains a read JAN code and a read scan time point, and turns “ON” a scan flag (step S803). If no scan information is input, the code identification unit 501 goes directly to step S804.

Next in step S804, the weight data (a) sent from the weight meter 202a is read, and processing is performed by the work time extraction unit 503, work time calculation unit 504, and abnormality detection unit 506.

Content of the processing which is performed in step S804 will be described in detail with reference to FIG. 9.

In FIG. 9, as in FIG. 8, the processing from step S901 to step S918 is repeatedly performed at intervals of, for example, one millisecond. Further, the processing from step S901 to step S911 is performed by the work time extraction unit 503, the processing from step S912 to step S913 is performed by the abnormality detection unit 506, and the processing from step S914 to step S918 is performed by the work time calculation unit 504.

At first, the weight data (a) sent from the weight meter 202a is obtained, and is taken as wᵢ (step S901). Next, an average value aᵢ for several samples of the weight data (a) obtained latest before wᵢ(step S902). For example, when five samples of the weight data is used, an average value aᵢ is obtained from average of five pieces of data added with, wᵢ, one-sample-previous data wᵢ₋₁, two-samples-previous data wᵢ₋₂, three-samples-previous data wᵢ₋₃, and four-samples-previous data wᵢ₋₄, which are read from the RAM 303 of the register terminal 101. Here, sampling is performed in cycles of one millisecond, and the five pieces of data refer to sampling data sampled at one millisecond before, two milliseconds before, . . . , four milliseconds before.

Next, in step S903, a variance value vᵢ is calculated from the same sampling data as described above. For example, variance of data of five samples is obtained.

In step S904, the variance value vᵢ calculated in step S903 and a predetermined threshold A are compared in size with each other. If the variance value vᵢ is greater than the threshold A, the flow goes to step S905. If the variance value vᵢ is not greater than the threshold A, the flow goes to step S908. By calculating the variance value vᵢ, it can be determined that a basket or an item has been subjected to contact, thereby changing the weight data.

In step S905, whether the contact flag is already “ON” or not is confirmed. Unless the contact flag is already “ON”, the flow goes to step S906. If the contact flag is already “ON”, the flow goes to step S912.

In step S906, the variance value vᵢ has become equal to or greater than the threshold before contact is made is indicated by the foregoing condition determination (step S904). This corresponds to a rising edge of the weight data (a) shown in FIG. 7, and can be determined to imply that the operator has made contact with an item. Therefore, this time point is obtained as an item contact time point.

In step S907, the item contact flag is set to “ON”, and the flow goes to next step S914.

If the item contact flag is here determined to be “ON” in step S905, whether or not the item get flag is “ON” is carried out, in step S912. If the item contact flag is determined to be “ON”, the flow goes to step S913 in order to perform abnormality recognition signal processing. Unless the item get flag is “ON”, it is determined that the variance value vᵢ merely exceeds the threshold A by an operation of getting an item, and that a steady work state continues. Therefore, the flow goes to step S914 without carrying out the abnormality recognition signal processing.

In step S913, it is recognized that scan work was performed in an unsteady state because any contact is indicated to have been made regardless of a state in which an item has been got. Therefore, the abnormality detection unit 506 performs the abnormality recognition signal processing.

On the other side, in step S908, if the variance value vᵢ is determined to be equal to or not greater than the threshold A, the variance value vᵢ and a predetermined threshold B are compared with each other in size, to confirm whether or not the variance value vᵢ is not greater and the contact flag is “ON”. If these two conditions are satisfied, the flow goes to step S909. If either one or two of the two conditions are not satisfied, the flow goes to step S914. If the two conditions are satisfied, an item is in contact and weight data recovers a state of a constant value, and the operator therefore seems to have picked up an item from a basket. Transition from step S908 to S914 indicates a segment in which the weight data (a) indicates change from a contact until getting or a segment of a constant value after getting until a next contact. The threshold B may be equal to the foregoing threshold A.

In step S909, an average value aᵢ calculated previously and an average value aᵢ₋₁ are compared in size with each other. If aᵢ is smaller than aᵢ₋₁, i.e., if the average value seems to have decreased, an item is determined to have been got, the flow goes to step S910. This is because a weight including a basket decreases to be lighter by getting an item from a basket and an average value of the weight data (a) decreases. Inversely, if aᵢ is not smaller than aᵢ₋₁, i.e., the flow goes to step S914. This indicates a state in which an item is not completely got.

In step S910, a time point at this time is obtained as an item get time point.

In step S911, the item get flag is set to “ON” and goes to step S914.

In step S914, a value is read with reference to the scan flag and the scan time point which are sent from the code identification unit 501.

In step S915, whether the scan flag is “ON” or not is determined. If the scan flag is “ON”, the flow goes to step S916. Unless the scan flag is “ON”, the flow goes to step S918.

In step S916, a contact scan time period and a get scan time period are calculated from an updated scan time point, an obtained item contact time point, and an obtained item get time point. A scan time interval is calculated from a scan time point before update.

In step S917, the item contact flag, item get flag, and scan flag are all set to “OFF”.

In step S918, the average value aᵢ and the variance value vᵢ calculated most recently are stored as one-sample-previous data into the RAM 303. Through the foregoing steps, processing performed in step S804 is completed.

Referring now back to FIG. 8, processing (step S805) concerning the weight data (b) is basically the same as described above. The term “item contact” may be replaced with “item put-start” and “item get” may be replaced with “item release”. The direction of inequality in condition determination may be reversed. In addition, for the weight data (b), in condition determination (in step S915) the scan flag is not referred to. Instead, a flag may be set which is turned “ON” if the variance value of sampling data not greater than the threshold A is continued for the determined time period T after releasing an item. This flag may be referred to.

Processing in subsequent steps S806 to S811 is performed by the work content analysis unit 505 included in the working state recognition unit 402.

In step S806, working property category information pieces of items read in S803 is obtained from the item content extraction unit 502.

In step S807, a contact scan time period ta, a get scan time period tb, a scan time interval ts, a scan put-start time period tc, and a scan release time period td, which are received from the work time calculation unit 504, and a basket collision detection signal, an item double pickup detection signal, and an item drop detection signal, which are received from the abnormality detection unit 506, are stored into the work history DB 403, associated with working property category information pieces of a corresponding item.

In step S808, the aforementioned read information pieces and detection signals, relating to items which are in an identical working category, are extracted from the work history DB 403 in accordance with a time history, on the basis of the working property category information pieces. Further, for each of the extracted read information pieces, latest five values are subjected to an intermediate value filter, and variance is calculated for each of the latest five values. Further, offsetting is performed on each signal. Further, a total number of handled items, and a value added with weights respectively for the handled items are calculated.

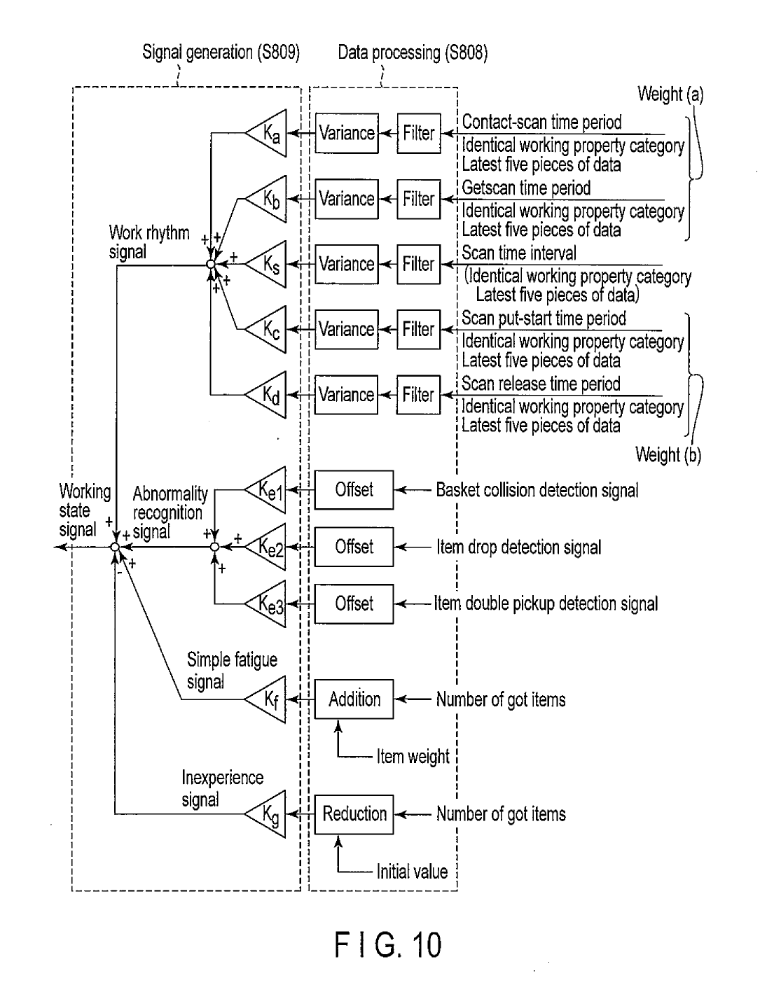

In step S809, variance of each of read information pieces, the detection signals, the weights of the handled items, and the total number of handled items are weighted, to obtain a work rhythm signal, an abnormality recognition signal, a simple fatigue signal, and an inexperience signal. Further, a working state signal which is a weighted sum of these signals is obtained. These signals will be described later with reference to FIG. 10.

In step S810, the signals obtained in step S809 are output outside.

In step S811, the signals obtained in step S809 are stored into the work history DB 403.

In step S812, processing for extracting the respective work time points and for calculating the respective work time periods is terminated by the working state recognition unit 402. Termination of the calculation processing can be achieved by switching off a power supply of the working state recognition unit 402.

The processing in steps S808 and S809 will now be described in detail with reference to FIG. 10.

At first, latest five values are subjected to an intermediate value filter, for each of read information pieces of the individual items, i.e., the contact scan time period to and get scan time period tb extracted from the weight data (a), the scan put-start time period tc and scan release time period td extracted from the weight data (b), and the scan time interval ts. Thereafter, variance values thereof are calculated. The variance of read information pieces of the individual items are respectively multiplied by weight coefficients (Ka, Kb, Kc, Kd, and Ks), and multiplication results thereof are then added up, thereby to obtain a work rhythm signal which expresses fluctuation during a repetition period of a series of processes from contact with an item to release thereof. The number of data values which are subjected to the filter may be appropriately determined in consideration of the number of items handled in one identical category and rapidness of signal update. Further, the average value filter may be used instead of the intermediate value filter. The calculated work rhythm signal is stored into the work history DB 403, with an operator ID and a working property category used as indices.

Each time when the detection signals, which are a basket collision detection signal, an item drop detection signal, and item double pickup detection signal, are generated, signals to offset are generated and are multiplied by weight coefficient (Ke1, Ke2, and Ke3). Thereafter, the multiplied values are added up, to obtain an abnormality recognition signal.

Further, a weighted sum of weights of scanned items (wherein a weight coefficient is Kf) is defined as a fatigue signal, and a simple fatigue signal as a signal which extracts a case of handling these items is obtained.

Further, an initial value is set, and weighting (wherein a weight coefficient is Kg) is performed by carrying out reduction from the initial value until a threshold is reached in proportion to the number of read items. An inexperience signal is thereby obtained wherein the inexperience signal becomes a constant value if the threshold is exceeded. As for the inexperience signal, the scan time interval ts for an operator is measured. The scan time interval is long in an initial stage in which the operator is inexperienced. As the operator experiences scanning to a certain extent, the scan interval shortens and further converges to the constant scan time interval ts which is the constant value. The scan time interval ts is set a value that is constantly reduced to a particular number of items got, and thereafter kept a constant value.

Through processing as described above, a working state signal is obtained as a signal which totally indexes (digitizes) a state of scan work of the operator by performing addition of the calculated work rhythm signal, abnormality recognition signal, and simple fatigue signal, and by reduction of the inexperience signal. As a numerical value of the working state signal increases, a fatigue degree of the operator increases and expresses a state that the operator is more fatigued or any unsteady state occurs to the operator. As the numerical value decreases, the fatigue degree of the operator decreases and expresses a state that the operator works comfortably. A reason why the inexperience signal is reduced is that fluctuation of work operation, mishandling, and simple fatigue due to an inexperienced state may not be reflected on the working state signal. The fluctuation of work operation corresponds to the work rhythm signal, and the mishandling in the work operation corresponds to the abnormality recognition signal. The simple fatigue corresponds to the simple fatigue signal.

In addition, the weight coefficients for the simple fatigue signal and inexperience signal reflect personal characteristics of an operator by appropriately correcting the weight coefficients in accordance with change of the scan time interval. More accurate working state signals can therefore be obtained. Further, by changing the weighting to the work rhythm signal, abnormality recognition signal, simple fatigue signal, and inexperience signal, the respective signals can be extracted individually. For example, when only the work rhythm signal is to be extracted, a weight coefficient for generating the abnormality recognition signal, simple fatigue signal, and inexperience signal may be set to “0(zero)”. Calculation of the work rhythm signal, abnormality recognition signal, simple fatigue signal, and inexperience signal, and calculation of the working state signal based on these signals are performed, on the basis of working property category information pieces of an item in scan work for the item. Sequential reading of relevant data from the work history DB 403, execution of calculation processing, and storing into the work history DB 403 are performed. A processing of filtering again an obtained working state signal may be performed. Further, if flow of data can be ensured insofar as functions as described above are not degraded, a place where the working state recognition unit 402 is equipped is not limited to the register terminal 101.

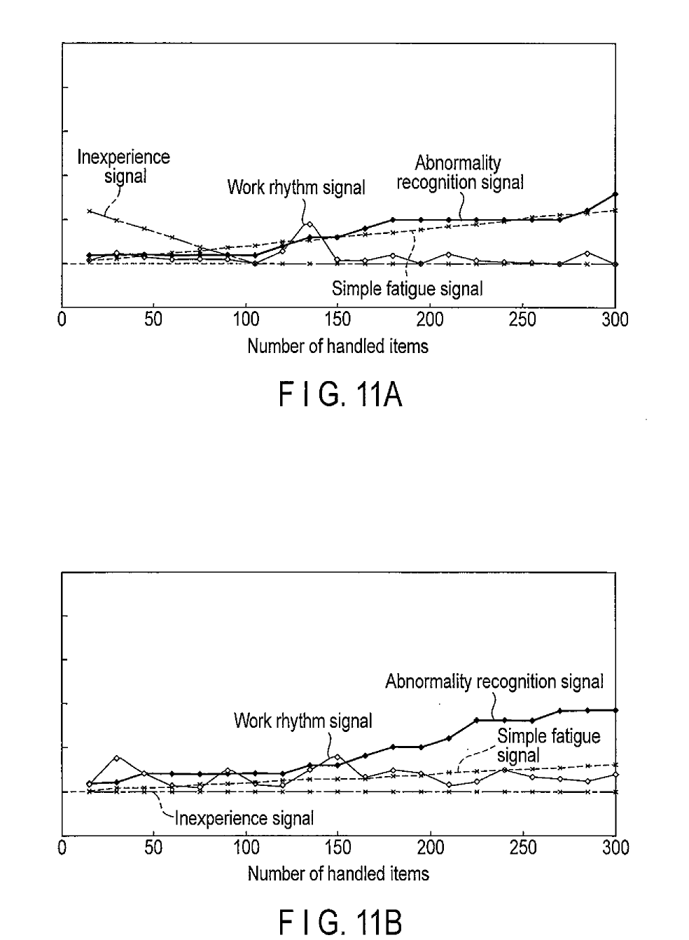

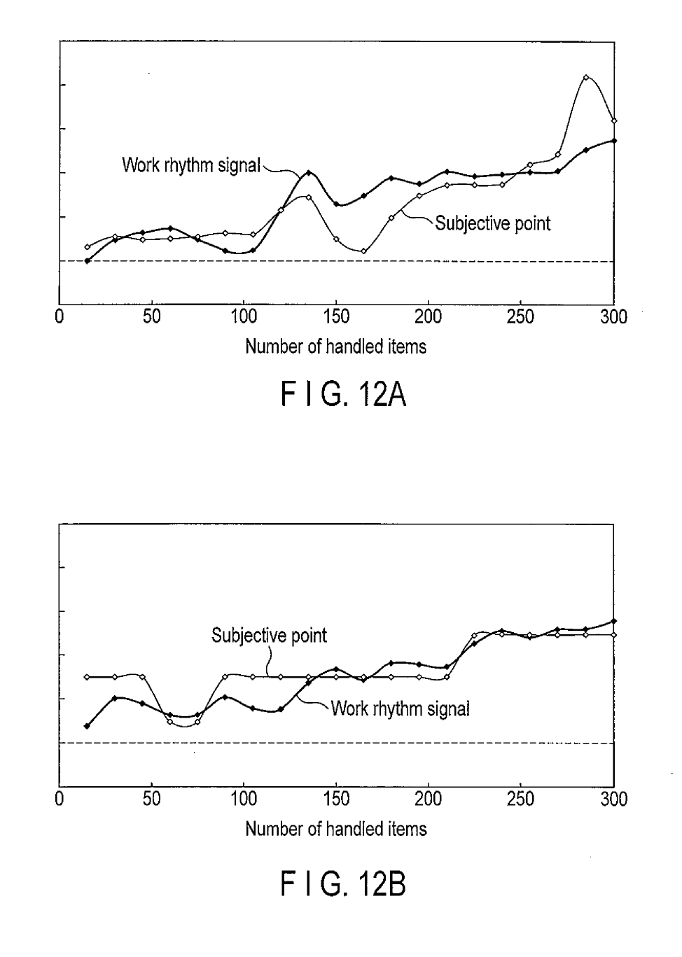

Now, examples of respective signals generated by the work content analysis unit 505 will be described with reference to FIGS. 11A, 11B, 12A, and 12B.

FIGS. 11A, 11B, 12A, and 12B illustrate data which handles three hundred items, as working property category categorized in one identical item, and the horizontal axes each represent the number of items handled while the vertical axes each represent a numerical value expressing a working state. As the numerical value increases, a more negative image is expressed, e.g., the working state deteriorated or a feel of fatigue increased. FIGS. 11A and 12A show working states of a female operator A. FIGS. 11B and 12B show working states of a male operator B. Further, FIGS. 11A and 11B show the work rhythm signal, abnormality recognition signal, simple fatigue signal, and inexperience signal. FIGS. 12A and 12B each show working state signals and subjective points calculated from four signals shown in FIGS. 11A and 11B. The subjective points each digitize a feel as a numerical value which an operator has during scan work. As the numerical value decreases, this represents a state in which the operator can work more comfortably. As the numerical value increases, this represents a more negative image due to a feel of fatigue. In FIGS. 12A and 12B, subjective points that the operators periodically report are plotted.

To generate the work rhythm signal in FIGS. 11A and 11B, data of fifteen samples is used to calculate filtering and variance for each of the read information pieces. The respective weight coefficients are arranged to satisfy Ka=Kb=Kc=Kd and Ks=0(zero). Referring to FIGS. 11A and 11B, the simple fatigue signal shown in FIG. 11A has a greater inclination than the simple fatigue signal shown in FIG. 11B. This is because FIG. 11A shows a simple fatigue signal for the female operator A who is considered to become more easily fatigued. Therefore, the simple fatigue signal for the female operator A has a greater inclination than the simple fatigue signal for the male operator B.

When an abnormality recognition signal is generated, a signal is generated which is incremented by one step (offset) each time basket collision detection, item drop detection, or item double pickup detection is performed.

When a simple fatigue signal is generated, the signal increases substantially linearly since handled items have substantially equal weights. If a weight of an item is large, the simple fatigue signal has a great inclination. If items categorized in different working property categories are handled during scan work and if an item categorized in the same working property category is handled, the signal is offset by an amount equivalent to handling of items in different working property categories at that part.

When an inexperience signal is generated, a signal is generated which uniquely decreases to 100 handled items and then becomes constant. This means that an operator becomes experienced before handling 100 items or so, and experience has no influence thereafter. Since the operator B is accustomed to scan work, the inexperience signal shown in FIG. 11B is constantly set to zero.

FIGS. 12A and 12B illustrate results of generating working state signals respectively from signals shown in FIGS. 11A and 11B and generated by the work content analysis unit 505. Though partially deviated, there is correlativity between the working state signal and subjective points. A fatigue degree of the operator can be found to have been measured indirectly by analyzing the scan work of the operator. By storing a history of working states of the operator, a working state of a steady state of the operator can be grasped. If the working state signal of the operator is greater than the working state signal of the steady state, an unsteady state can be determined.

The working state signal is generated by collecting items having identical working property category information. Therefore, when scan work is completed for a plurality of items, a plurality of working state signals are generated on the basis of a plurality of items of working property category information. The plurality of working state signals and time points are collected together, and are subjected to processing such as averaging, to obtain a total working state signal. The total working state signal expresses more precisely a working state of an operator. If the number of items totally handled is small and if the number of handled items having identical category information pieces is also small, sufficient data for obtaining proper working state signals is not always collected. To avoid this situation, a set of values for which the aforementioned weight coefficients are set as working property category information, based on item parameters. For example, a standard item is determined to become a standard in working property categorization, and a value of the weight coefficients of working property category information pieces thereof is taken as a standard value for a weight coefficient. Relevant weight coefficients Ka and Kb are set to be smaller than the standard value when an item, which has a great weight, a shape difficult to grab, and a code adhesion surface difficult to read, is handled. In this manner, an influence by which a time period from pickup of an item to scanning thereof originally tends to extend can be cancelled, and working state signals can be generated together with the standard item.

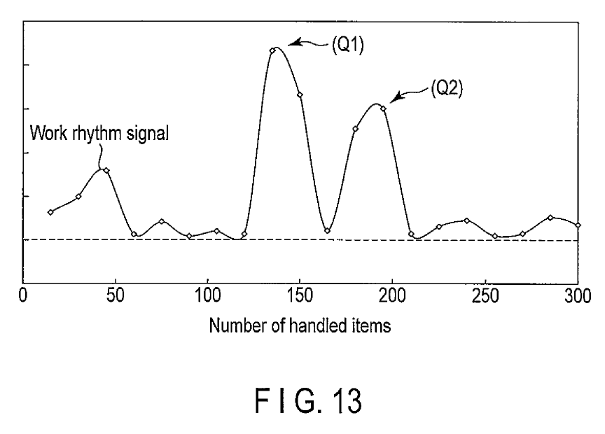

FIG. 13 shows the work rhythm signal where the same data as used when the work rhythm signal for the operator B shown in FIG. 11B was generated is used for time points calculated by the work time calculation unit 504 and weight coefficients for the time points are set to Ka=Kb and Ks=Kc=Kd=0(zero) by the work content analysis unit 505.

In FIG. 13, maximum values which do not appear in the work rhythm signal in FIG. 11B can be confirmed near points where the numbers of handled items denoted at (Q1) and (Q2) are respectively 140 and 190. At this time, a shopper said something to the operator B during scan work. Since the signal has been weighted about the contact scan time period and the get scan time period, work of picking up items from a basket is found to have been influenced by a particular state in which something has been said to the operator. Thus, a plurality of signals focused on respectively different viewpoints are generated simultaneously by generating a plurality of work rhythm signals for identical read information pieces, at the work content analysis unit 505, with weight coefficients thereof changed. A particular state can then be estimated. Inversely, personal characteristics such as what kind of states an operator sensitively reacts to or does not react to can be expressed by preparing various combinations of weight coefficients, by simultaneously generating work rhythm signals using the combinations, and by comparing these signals with signals for a different operator.

The work rhythm signal means indexing of mental fatigue of an operator, fluctuates up and down depending on the procedure of work or the operator's own mental conditions, and expresses a result of influence thereof indirectly as a parameter of time variance. The abnormality recognition signal means an index which regards a sudden phenomenon as accumulation of mental burdens. The simple fatigue signal means indexing of a physical burden caused by momentum. Mental and physical loads can be respectively mental and physical burdens, depending on operator's characteristics. The mental and physical burdens cause a sense of fatigue and physical fatigue through complex mechanisms. A sense of fatigue and physical fatigue consequently function as working property and a working state. Therefore, a result of quantitatively grasping a working state can be said to estimate substantially probably the sense of fatigue or physical fatigue. According to the explanation above, a state in which a work rhythm signal is constant or has a constant inclination is a steady working state. A state in which a work rhythm signal fluctuates can be understood as an unsteady working state. Further, the abnormality recognition signal, the simple fatigue signal, and the inexperience signal can be interpreted as respectively expressing an unsteady working state, steady work, and the change from unsteady work to steady work. Therefore, the working state signal which adds up these signals can be said to be a signal which includes steady work and unsteady work together.

The obtained working state signal may be compared with a predetermined value, and may be arbitrarily displayed on the scanner touch panel 110 or the like. Otherwise, a display device may be provided in the vicinity of a register terminal or a predetermined place. Particularly, if a working state is determined to have improved, an operator can be made aware of the excellent working state by presenting a result thereof to the operator, which vitalizes the operator thereafter. Further, data can be received by a shop server, and a later criterion can be prepared based on the data. Next, an example of determination on a working state signal will be described. If the working state signal is greater than a specified value in a number of got items, more mental burdens can be determined to have accumulated than in a steady state. If fluctuation of the working state signal is large, an unsteady state in which a work rhythm is disturbed can be determined to be occurring. Settling of the fluctuation can be determined to mean that the state has improved. The fluctuation of the work rhythm is calculated, for example, by calculating time derivatives (differences) and variance as displacements and by comparing them with thresholds.

In addition, long term changes in working states can be seen by referring, in time order, to data of an identical person which is stored in the work history DB 403 and by referring to changes thereof. Further, a part where a difference of a working state to a different person exists can be pointed out by comparison with the different person.

Further, in the above description, the checkout scanner 108 has been described in the case of the vertical type fixed to a counter. However, in a similar manner, application is possible further to scan work with use of a type fixed to a counter with a scanner surface faced upward or a handy scanner. The person who carries out scan work is not limited to an operator and may be, for example, a shopper at a self service register. In the case of only one sensor table, a system which analyzes a working state, for example, as shown in the example of FIG. 13, can be provided within a range of the sensor table.

Further, the present embodiment has been described with respect to scan work for purchasing items. However, the work is not limited to items as target objects handled and may be for other objects. For example, the embodiment may be used in a factory, to measure a working state of work in which an operator picks up a target object to work with from a particular place and repeats a particular work. For example, in a line in a production plant, the embodiment can be applied to working state measurement in work of distributing target objects. The embodiment may be also applied to the packing/packaging work for target objects such as postal matters.

According to the embodiment as described above, a working state during work can be measured in real time, without directly attaching a sensor to an operator. Working states of an operator can be accurately grasped by comparing work content and work features thereof using a small amount of data. Results thereof can be quickly analyzed and output.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A checkout apparatus comprising:
a counter configured to be embedded at least one weight meter and to be put at least one of target objects;
a scanner configured to read codes attached to the target objects;
a register terminal configured to settle payment for the target objects; and
a recognition unit configured to identify the target objects by referring to working property category information pieces indicating a category in scan work for the target objects, based on the codes read by the scanner, and to obtain signals that represent states each including one of steady work and unsteady work for an operator, based on a time history of a weight of the target objects measured by the weight meter.

2. The apparatus according to claim 1, wherein the recognition unit comprises:
an extraction unit configured to extract a time point when the codes are read by the scanner as a scan time point, and
if the weight meter is provided only in an upstream side of the counter, the upstream being a place where the target objects is placed before the target objects is read in the scan work, the extraction unit extracts at least one of a target object contact time point and a target object get time point, the target object contact time point being a time point of making contact with a target object of the target objects, the target object get time point being a time point when the target object is got,
if the weight meter is provided only in a downstream side of the counter, the downstream being a place where the target objects is placed after the target objects is read, the extraction unit extracts at least one of a target object put-start time point and a target object release time point, the target object put-start time point being a time point of starting putting the target object read, and the target object release time point being a time point of releasing the target object from a hand,
if the weight meter is provided in each of both the upstream side and the downstream side, the extraction unit extracts at least one of the target object contact time point, the target object get time point, the target object put-start time point, and the target object release time point, thereby configured to obtain the extracted at least one as at least one of time information pieces; and
a calculation unit configured to calculate a scan time period which is a time interval between one another of the scan time points,
if the weight meter is provided only in the upstream side, the calculation unit calculates at least one time difference among the scan time point, the target object contact time point, and the target object get time point,
if the weight meter is provided only in the downstream side, the calculation unit calculates at least one time difference among the scan time point, the target object put-start time point, and the target object release time point,
if the weight meter is provided on each of both the upstream side and the downstream side, the calculation unit calculates at least one time difference among the scan time point, the target object contact time point, the target object get time point, the target object put-start time point, and the target object release time point, thereby configured to obtain the extracted at least one time difference as at least one of read information pieces.

3. The apparatus according to claim 1, wherein the recognition unit further comprises a detection unit configured to detect an abnormal state that indicates a change of the weight of the target objects other than changes during a steady state in the scan work of the operator.

4. The apparatus according to claim 3, wherein the recognition unit weights a variance value of at least one of the read information pieces, calculates a work rhythm signal corresponding to a repetition time period of repeating a series of processes from contact on the target object to release of the target object from the hand, calculates an abnormality recognition signal corresponding to a value added with the number of the abnormal states detected by the detection unit, calculates a fatigue signal corresponding to a value obtained by multiplying weights of the target objects read, calculates an inexperience signal corresponding to a value that reduces to a threshold in accordance with the number of the target objects read, the value being a constant value when the value exceeds the threshold, and
the recognition unit further comprises an analysis unit configured to generate a work state signal indicating a weighted sum of the work rhythm signal, the abnormality recognition signal, the simple fatigue signal, and the inexperience signal.

5. The apparatus according to claim 1, wherein the working property category information pieces are parameters which indicate easiness of the scan work of reading the target objects, the easiness being determined by a shape of the target objects, a weight of the target objects, a position of the codes attached to the target objects, and a state of content of the target objects.

6. The apparatus according to claim 4, wherein the analysis unit generates the work state signal, based on the working property category information pieces and an identification information piece which identifies the operator.

7. The apparatus according to claim 4, wherein the analysis unit generates a plurality of work rhythm signals by changing a weight to the read information pieces, and extracts a particular work state from the plurality of work rhythm signals.

8. The apparatus according to claim 4, wherein if the weighted sum is greater than a second threshold or if a displacement of the work state signal is greater than a third threshold, the recognition unit determines a work state of the operator to be an unsteady state.

9. The apparatus according to claim 1, wherein the weight meter is provided on the counter where the scanner is provided to stand, in at least one of an upstream side of the counter and a downstream side of the counter, the upstream being a place where the target objects is placed before the target objects is read, the downstream being a place where the target objects is placed after the target objects is read.

10. A working state measurement apparatus comprising:
a first space configured to put at least one of target objects not worked;
a second space configured to put at least one of the target objects worked;
a weight meter configured to be provided in at least one of the first space and the second space;
a first extraction unit configured to extract a work time periods from data of the weight meter, for each target object;
a first generation unit configured to weight a variance value of the work time period, and generate a work rhythm signal corresponding to a repetition time period of repeating a series of processes from contact on a target object of the target objects to release the target object from a hand;
a second generation unit configured to generate a fatigue signal and an inexperience signal, the fatigue signal corresponding to a value obtained by multiplying weights of the target objects worked with, the inexperience signal corresponding to a value that reduces to a threshold in accordance with the number of the target objects read, the value being a constant value when the value exceeds the threshold; and
a third generation unit configured to generate a work state signal as a weighted sum of the work rhythm signal, the fatigue signal, and the inexperience signal.

11. The apparatus according to claim 10, further comprising:
a fourth generation unit configured to generate a plurality of work rhythm signals by changing a weight to the work time period; and
a second extraction unit configured to extract a particular work state from the plurality of work rhythm signals.

12. A checkout method comprising:
preparing a counter embedded at least one weight meter and put at least one of target objects;
reading codes attached to each of the target objects;
settling payment for the target objects; and
identifying the target objects by referring to working property category information pieces indicating a category in scan work for the target objects, based on the codes read, and
obtaining signals that represent states each including one of steady work and unsteady work for an operator, based on a time history of a weight of the target objects measured.

13. The method according to claim 12, wherein the obtaining the signals comprises:
extracting a time point when the codes are read by the scanner as a scan time point, and
if the weight meter is provided only in an upstream side of the counter, the upstream being a place where the target objects is placed before the target objects is read in the scan work, the extracting the time point extracts at least one of a target object contact time point and a target object get time point, the target object contact time being a time point of making contact with a target object of the target objects, the target object get time point being a time point when the target object is got,
if the weight meter is provided only in a downstream side of the counter, the downstream being a place where the target objects is placed after the target objects is read, the extracting the time point extracts at least one of a target object put-start time point and a target object release time point, the target object put-start time point being a time point of starting putting the target object read, and the target object release time point being a time point of releasing the target object from a hand,
if the weight meter is provided in each of both the upstream side and the downstream side, the extracting the time point extracts at least one of the target object contact time point, the target object get time point, the target object put-start time point, and the target object release time point, thereby obtains the extracted at least one as at least one of time information pieces; and
calculating a scan time period which is a time interval between one another of the scan time points,
if the weight meter is provided only in the upstream side, the calculating the scan time period calculates at least one time difference among the scan time point, the target object contact time point, and the target object get time point,
if the weight meter is provided only in the downstream side, the calculating the scan time period calculates at least one time difference among the scan time point, the target object put-start time point, and the target object release time point,
if the weight meter is provided on each of both the upstream side and the downstream side, the calculating the scan time period calculates at least one time difference among the scan time point, the target object contact time point, the target object get time point, the target object put-start time point, and the target object release time point, thereby obtains the extracted at least one time difference as at least one of read information pieces.

14. The method according to claim 12, wherein the obtaining the signals further comprises detecting an abnormal state that indicates a change of the weight of the target objects other than changes during a steady state in the scan work of the operator.

15. The method according to claim 14, wherein the obtaining the signals weights a variance value of at least one of the read information pieces, calculates a work rhythm signal corresponding to a repetition time period of repeating a series of processes from contact on the target object to release of the target object from the hand, calculates an abnormality recognition signal corresponding to a value added with the number of the abnormal states detected, calculates a fatigue signal corresponding to a value obtained by multiplying weights of the target objects read, calculates an inexperience signal corresponding to a value that reduces to a threshold in accordance with the number of the target objects read, the value being a constant value when the value exceeds the threshold, and
further comprises generating a work state signal indicating a weighted sum of the work rhythm signal, the abnormality recognition signal, the simple fatigue signal, and the inexperience signal.

16. The method according to claim 12, wherein the working property category information pieces are parameters which indicate easiness of the scan work of reading the target objects, the easiness being determined by a shape of the target objects, a weight of the target objects, a position of the codes attached to the target objects, and a state of content of the target objects.

17. The method according to claim 15, wherein the generating the work state signal is based on the working property category information pieces and an identification information piece which identifies the operator.

18. The method according to claim 15, wherein the generating the work state signal generates a plurality of work rhythm signals by changing a weight to the read information pieces, and extracts a particular work state from the plurality of work rhythm signals.

19. The method according to claim 15, wherein if the weighted sum is greater than a second threshold or if a displacement of the work state signal is greater than a third threshold, the obtaining the signals determines a work state of the operator to be an unsteady state.
